(19) United States
(12) Patent Application Publication
(10) Pub. No.: US 2002/0004337 A1
(43) Pub. Date: Jan. 10, 2002

(54) Electrical connector

(76) Inventor: Chun-Hsiang Chiang, Taipei Hsien (TW)

Correspondence Address: Robert J. Zeitler, MOLEX INCORPORATION, 2222 Wellington Court, Lisle, IL, 60532, US

(21) Appl. No.: 09/838,914

(22) Filed: Apr. 20, 2001

(30) Foreign Application Priority Data
May 2, 2000 (TW) 89207473

(51) Int. Cl. H01R 13/648

(52) U.S. Cl. 439/607

(57) ABSTRACT

An electrical connector includes an electrically insulative body and a conductive shield. The electrically insulative body has a plurality of terminals. Each terminal has a tail respectively clamped on a circuit board. The electrically insulative body has two backwardly extended locating blocks at two sides. Each locating block has a locating groove which receives the circuit board upon connection of the terminals to the respective contacts of the circuit board. The locating blocks also include flexible arms with upright portions adapted for engaging into respective retaining apertures on the circuit board. The conductive shield includes backwardly extended grounding arms which also include retainers adapted for engaging into respective apertures on the circuit board. The retainers and retaining apertures secure the connector to the circuit board against vertical as well as forward-backward/leftwards-rightwards horizontal displacement.

### FIELD OF THE INVENTION

The present invention relates to an electrical connector and, more particularly, to an improved structure for a straddle mount electrical connector, which is stably secured to the circuit board before as well as after the tails of the terminals have been affixed to circuit traces on the circuit board by way of a surface mounting technique (SMT), such as by soldering.

### BACKGROUND OF THE INVENTION

FIG. 1 is a perspective view of a prior art straddle mount electrical connector 1 relative to a circuit board 2. The connector 1 comprises an electrically insulative body 10, and two vertically spaced rows of terminals 100 provided in the electrically insulative body 10. Each terminal 100 has a rear clamping tail 101. The clamping tails 101 of the terminals 100 are respectively clamped on top and bottom sidewalls of the circuit board 2 and forced into contact with respective contacts (not shown) at the circuit board 2, and then a SMT is employed to mechanically and electrically connect the connector 1 to the circuit board 2.

Because the clamping tails 101 of the terminals 100 are respectively clamped on top and bottom sidewalls of the circuit board 2, the clamping tails 101 only prohibit vertical displacement between the connector 1 and the circuit board 2. There is only small frictional resistance between the connector 1 and the circuit board 2 in forward-backward and leftwards-rightwards horizontal directions. Therefore, during SMT operation, possible forward-backward or leftwards-rightwards vibration cannot be eliminated, resulting in inaccurate contact between the clamping tails 101 and the respective contacts at the circuit board, or tilting/deformation of the terminals 100. In this case, SMT operation may not be workable, and a defective product may be produced. If the terminals 100 are all welded to the circuit board 2 by SMT operation, improper application of force during a plug and pull action or frequent plug and pull action may cause the terminals 100 of the connector 1 to displace. Therefore, the yielding rate cannot be greatly improved according to this conventional design.

Further, the design cannot prevent the connection of the connector 1 to the circuit board 2 in a wrong direction. This problem happens easily during a high-speed mass production operations. If the connector is connected to the circuit board in a wrong direction, the terminals 100 cannot be accurately connected to the respective contacts, and the product becomes useless. This problem must be eliminated.

The present invention provides an electrical connector which overcomes the problems presented in the prior art and which provides additional advantages over the prior art, such advantages will become clear upon a reading of the attached specification in combination with a study of the drawings.

### OBJECTIVES AND SUMMARY OF THE INVENTION

A general object of the present invention to provide an electrical connector which can be stably and accurately fastened to the circuit board, preventing displacement in vertical direction as well as in the forward-backward and leftward-rightward horizontal directions.

Another object of the present invention is to provide an electrical connector which provides accurate contact between clamping tails of the electrical connector and the respective contacts on a circuit board.

A further object of the present invention is to provide an electrical connector which eliminates tilting/deformation of the terminals of the connector.

Another object of the present invention is to provide an electrical connector which is unable to be connected with the circuit board in the wrong direction.

Briefly, and in accordance with the foregoing, the present invention discloses an improved electrical connector. The electrical connector includes an electrically insulative body and a conductive shield. The body has two backwardly extended locating blocks at two sides. Each locating block has a locating groove which receives the circuit board upon connection of the terminals to the respective contacts of the circuit board. Each locating block further includes a flexible arm with an upright portion for engaging into a respective retaining aperture on the circuit board. The conductive shield includes two backwardly extending grounding arms. Each grounding arm has a retainer adapted for engaging into a respective retaining aperture of the circuit board.

### BRIEF DESCRIPTION OF THE DRAWINGS

FIG. 1 is a perspective view of a prior art straddle mount electrical connector and a perspective view of a circuit board;

FIG. 2 is an exploded perspective view of an electrical connector which incorporates the features of a first embodiment of the present invention, and a perspective view of a circuit board;

FIG. 3 is a fragmentary perspective view of a portion of the grounding arm of the electrical connector of FIG. 2;

FIG. 4 is perspective view showing the electrical connector of the first embodiment of the present invention assembled with the circuit board, which is shown in perspective;

FIG. 5 is a cross-sectional view of a portion of the first embodiment of the electrical connector and the circuit board, with the portion of the connector attached to the circuit board;

FIG. 6 is a fragmentary perspective view of a grounding arm which incorporates features of a second embodiment of the present invention;

FIG. 7 is an exploded perspective view of an electrical connector which incorporates the features of a third embodiment of the present invention and a perspective view of a circuit board;

FIG. 8 is a fragmentary perspective view of a flexible arm and locating block of the electrical connector of FIG. 7;

FIG. 9 is a perspective view showing the electrical connector of the third embodiment of the present invention assembled with the circuit board, which is shown in perspective; and

FIG. 10 is a cross-sectional view of a portion of the third embodiment of the electrical connector and the circuit board, with the portion of the electrical connector attached to the circuit board.

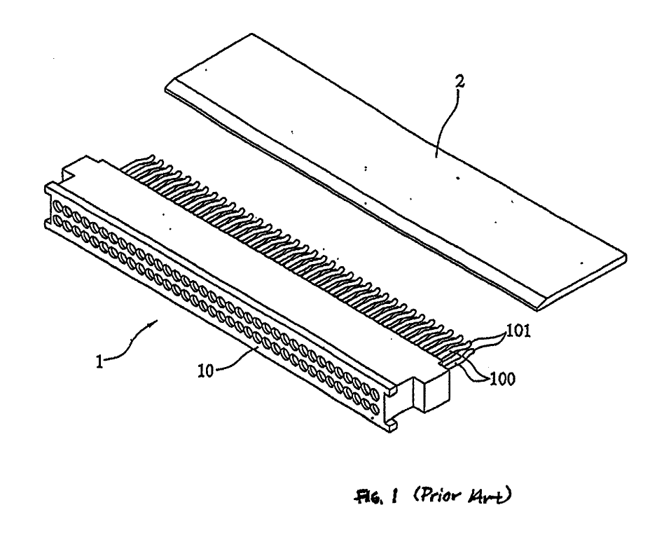

### DETAILED DESCRIPTION OF THE PREFERRED EMBODIMENT

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

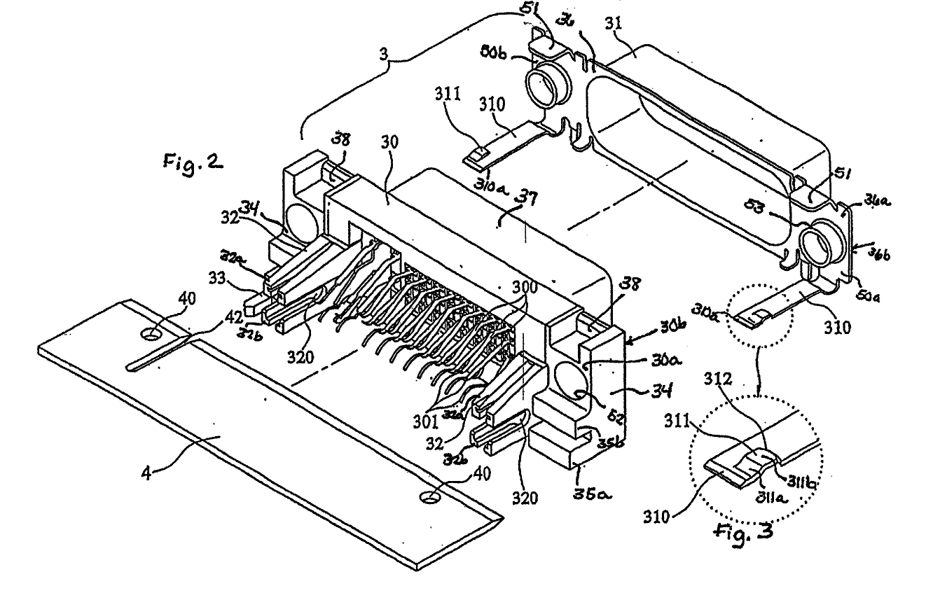

A first embodiment of the electrical connector 3 of the present invention is shown in FIGS. 2-5. The connector 3 includes an electrically insulative body 30, and a conductive shield 31 which covers a portion of the electrically insulative body 30.

The electrically insulative body 30 is a molded one-piece component composed of a dielectric material such as plastic or the like. The electrically insulative body 30 has a backside 30a and a front side 30b. A generally rectangular shaped portion 37 is centrally located and extends from the front side 30b of the insulative body 30. The insulative body 30 is provided with two rows of terminals 300 which extend through the body 30 and which are centrally located and extend from the back side 30a of the insulative body 30. Each terminal 300 has a rear clamping tail 301 adapted for clamping on a respective contact of a circuit board 4. The clamping tails 301 of the upper row of terminals 300 mate with the contacts (not shown) on the top side of the circuit board 4 and the clamping tails 301 of the lower row of terminals 300 mate with the contacts (not shown) on the bottom side of the circuit board 4.

The electrically insulative body 30 also includes two locating blocks 32 bilaterally disposed at the back side 30a thereof. Each locating block 32 includes a pair of upper arms 32a and a pair of lower arms 32b which extend parallel to the terminals 300. The upper arms 32a are spaced apart from each other. The lower arms 32b are spaced apart from each other. An elongated groove 320 is positioned between the upper arms 32a and the lower arms 32b and also extends parallel to the terminals 300. The groove 320 is used to assist in the positioning of the circuit board 4 as discussed herein.

The insulative body 30 further includes base portions 34 provided on each end thereof. Each base portion 34 includes a first shoulder 35a and a second shoulder 35b. The first shoulder 35a and the second shoulder 35b extend rearwardly from the backside 30a of the base portion 34. A passageway (not shown) is provided between the first shoulder 35a and the second shoulder 35b. Each base portion 34 also includes a recess 38 and an aperture 52 below each recess 38 and above the second shoulder 35b. The recess 38 defines a shoulder 38a on the front side of the base portion 34.

A lead-in rod 33 is provided on one of the base portions 34 of the insulative body 30. The lead-in rod 33 extends rearwardly from the base portion 34 parallel to the locating block 32. The lead-in rod 33 is aligned vertically with the groove 320.

The conductive shield 31 includes a plate 36 having a first side 36a, a second side 36b, a first end 50a, and an opposite second end 50b. A generally rectangular skirt 39 depends from the second side 36b of the plate 36. Two bilaterally suspended grounding arms 310 extend from the first side 36a of the plate 36 for welding to respective grounding contacts (not shown) at the bottom side of the circuit board 4. One grounding arm 310 is positioned near the first end 50a of the plate 36 and a second grounding arm 310 is positioned near the second end 50b of the plate 36. Each grounding arm 310 has an upwardly protruding retainer 311 positioned near the free end 310a of the grounding arm 310. In FIGS. 2 and 3, the retainer 311 is a protruded hook formed by stamping. One end of the retainer 311 is connected to the respective grounding arm 310 and leads to a ramped surface 311a. The ramped surfaced 311a leads to a horizontal surface 311b which terminates in a smoothly arched face 312 suspended in the open air at the opposite end of the retainer 311. In a second embodiment, shown in FIG. 6, the retainer 315 is shaped like a semispherical shell protruded from the top of the grounding arm 316. The retainer 315 includes a ramped surface 317 which leads to a vertical end wall 318.

Two tabs 51 are located near the top of the conductive shield 31 and are spaced from either end 50a, 50b of the conductive shield 31. Cylindrically shaped protrusions 53 are positioned below the tabs 51. The tabs 51 and protrusions 53 are used to secure the conductive shield 31 to the insulative body 30.

When connecting the insulative body 30 to the conductive shield 31, the skirt 39 of the conductive shield 31 is placed around the portion 37 of the insulative body 30 and the front side 36a of the plate 36 sits adjacent to the backside 30b of the insulative body 30. Tabs 51 are bent over the shoulder 38a and the protrusions 53 are inserted into the apertures 52. The grounding arms 310 pass through the passageways (not shown) located on the base portion, preferably between the first shoulder 35 and the second shoulder 36.

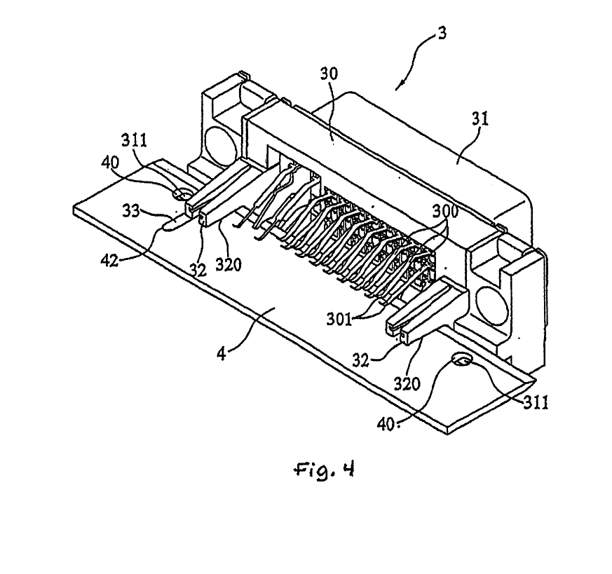

The circuit board 4 to which the connector 3 is electrically connected includes two retaining apertures 40 and a lead-in slot 42 located near the forward, or leading, edge of the circuit board 4. The retaining apertures 40 correspond to the retainer 311 of each grounding arm 310 of the conductive shield 31. The lead-in slot 42 corresponds to the lead-in rod 33 of the insulative body 30. Therefore, the connector 3 can be clamped on the circuit board 4 only when aiming the connector 3 at the circuit board 4 in the correct direction for enabling the lead-in rod 33 to be inserted into the lead-in slot 42, as shown in FIG. 4. If the connector 3 is not attached to the circuit board 4 in the correct direction, the lead-in rod 33 will be stopped at the edge of the circuit board 4, and prohibited from being connected to the circuit board 4. Therefore, the connector 3 can easily and accurately be installed in the circuit board 4 without causing a vibration.

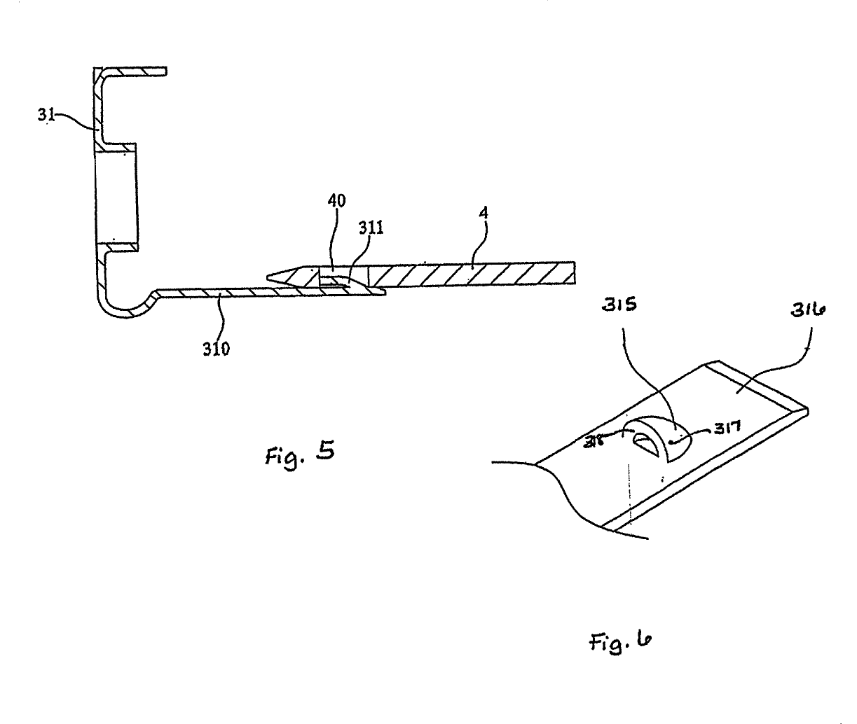

When mechanically and electrically connecting the connector 3 to the circuit board 4, the circuit board 4 is inserted into the groove 320 of each locating block 32 of the electrically insulative body 30 and lead-in rod 33 is inserted into the lead-in slot 42. The circuit board 4 is inserted between the tails 301 of the upper row of terminals and the tails 301 of the lower row of terminals. As the circuit board 4 is moved into the groove 320 the ramped surface 311 a of the retainer 311 slides along the edge of the retaining aperture 40. Once the circuit board 4 is moved all the way into the groove 320 the horizontal surface 311b is forced within the retaining aperture 40 and the arched face 312 rests against the wall of the retaining aperture 40, as shown in FIGS. 4 and 5. In the second embodiment, as the circuit board 4 is moved into the groove 320 the ramped surface 317 of the retainer 315 slides along the edge of the retaining aperture 40. Once the circuit board 4 is moved all the way into the groove 320 the vertical wall 318 is forced into the retaining aperture 40. By means of the clamping and retaining effect of the clamping tails 301 of the terminals 300, the locating groove 320 of each locating block 32 of the electrically insulative body 30 and the retainer 311 of each grounding arm 310 of the conductive shield 31, the connector 3 is stably positioned on the circuit board 4 and, the terminals 300 are accurately maintained in contact with the respective contacts at the circuit board 4 for easy application of SMT operation. After SMT operation, the connection of the connector 3 to the circuit board 4 is strong enough to resist against push and pull force in all directions.

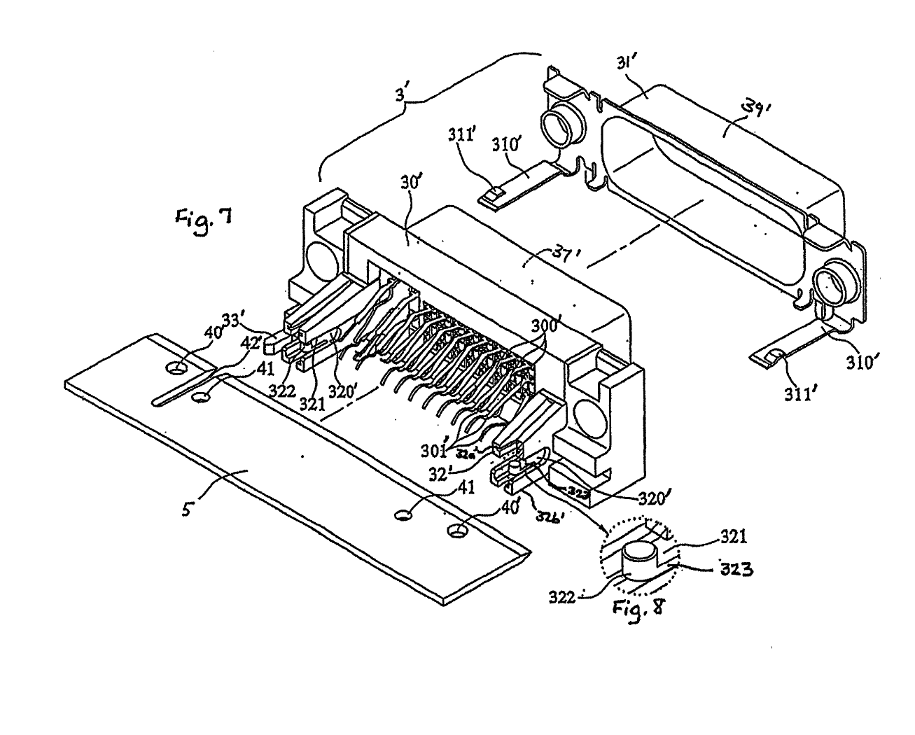

A third embodiment of the electrical connector 3′ of the present invention is shown in FIGS. 7-10. The third embodiment of the electrical connector 3′ is identical to the first embodiment of the electrical connector 3 except that a flexible suspended arm 321 is disposed in the respective locating groove 320. Accordingly, like elements are denoted by like reference numerals but with a prime after the reference numerals. It is to be understood that the retainer 315 shown in FIG. 6 can be used instead of the retainer 311.

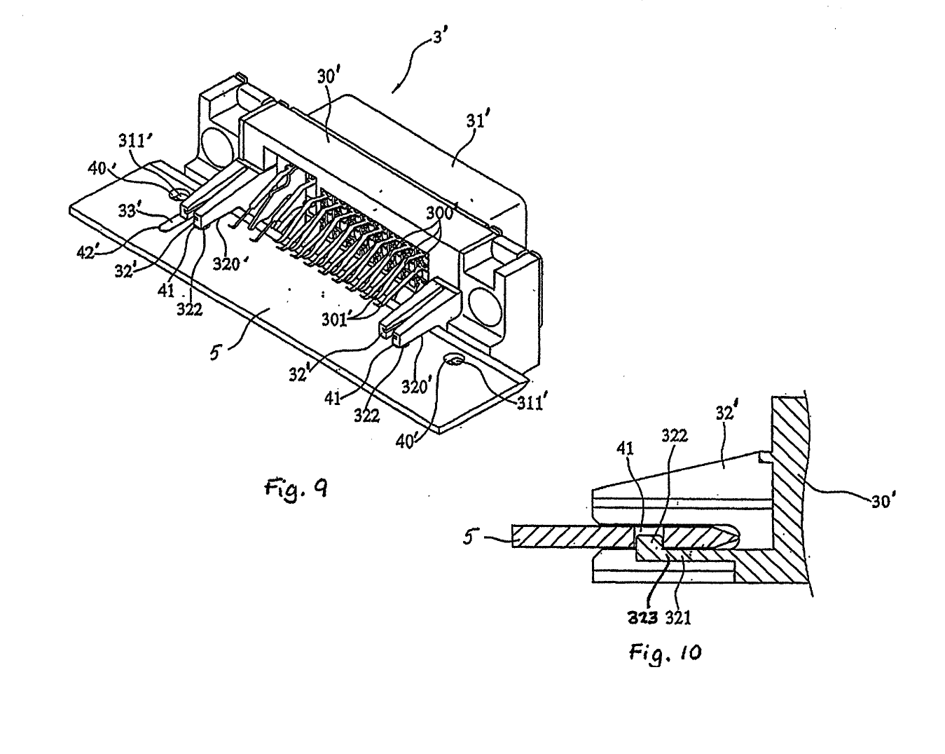

The flexible arm 321 includes an elongated portion 323 which is cantilevered from the locating block 32′ and extends between the upper arms 32a′ and the lower arms 32b′ and an upright portion 322 at the free end of the elongated portion 323 adapted for fastening to a respective retaining aperture 41 on the circuit board 5. The free end of the flexible arm 321 is capable of movement in the vertical direction. As the circuit board 5 is moved into the groove 320′, the upright portion 322 will contact the bottom surface of the circuit board 5 and the flexible arm 321 will be forced downward. When the upright portion 322 becomes aligned with the respective retaining aperture 41, the upright portion 322 will flex or spring upward into the retaining aperture 41. After engagement of the circuit board 5 into the locating groove 320′ of each locating block 32′ of the electrically insulative body 30′, the terminals 300′ are respectively clamped on the circuit board 5, the retainers 311′ of the grounding arms 310′ of the conductive shield 31′ are respectively engaged into the retaining apertures 40′ of the circuit board 5, and the upright portions 322 of the flexible arms 321 of the electrically insulative body 30′ are respectively engaged into the retaining apertures 41 of the circuit board 5, as shown in FIGS. 9 and 10, and therefore the connector 3 is stably secured to the circuit board 5.

As indicated above, the invention provides an electrical connector 3, 3′ that can be accurately and stably secured to a circuit board before as well as after the application of SMT operation. The electrical connector 3, 3′ functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electrical connector for mounting on an edge of a circuit board, the electrical connector comprising:
an electrically insulative body having a plurality of terminal passageways;
a plurality of terminals received withing the terminal passageways, each of the terminals having a tail for connection to the circuit board; and
a conductive shield covering a portion of the electrically insulative body, the conductive shield including at least one grounding arm extending therefrom, the at least one grounding arm being generally parallel to a top surface of the circuit board and including a retainer for engagement with a respective retaining aperture on the circuit board.

2. An electrical connector as defined in claim 1, the body further including a rod extending therefrom for engaging a slot on a leading edge of the circuit board.

3. An electrical connector as defined in claim 1, further including at least one locating block, the at least one locating block including a groove which receives the circuit board.

4. An electrical connector as defined in claim 3, wherein the at least one locating block includes a flexible arm disposed in the groove, the flexible arm including a portion for engaging a respective retaining aperture on the circuit board.

5. An electrical connector as defined in claim 3, further including a rod extending from the body for engaging a slot on a leading edge of the circuit board.

6. An electrical connector as defined in claim 3, wherein the retainer of the at least one grounding arm is a protruded hook having a first end connected to the grounding arm and a second end suspended therefrom.

7. An electrical connector as defined in claim 6, wherein the second end of the protruded hook terminates in a smoothly faced arched face.

8. An electrical connector as defined in claim 3, wherein the retainer of the at least one grounding arm is a semispherical shell which protrudes therefrom.

9. An electrical connector as defined in claim 1, wherein the terminals are arranged into two rows, each the terminal having a clamping tail adapted for clamping on the circuit board and the circuit board is received between the two rows of terminals.

10. An electrical connector as defined in claim 1, wherein the retainer of the at least one grounding arm is a protruded hook having a first end connected to the grounding arm and a second end suspended therefrom.

11. An electrical connector as defined in claim 10, wherein the second end of the protruded hook terminates in a smoothly arched face.

12. An electrical connector as defined in claim 1, wherein the retainer of the at least one grounding arm is a semispherical shell which protrudes therefrom.

13. An electrical connector as defined in claim 3, wherein the at least one grounding arm extends through a passageway in the locating block.

14. An electrical connector comprising:
an electrically insulative body;
a plurality of terminals provided on the body, each the terminal having a tail for surface mount connection to a circuit board; and
a rod extending from the body for engaging a slot on a leading edge of the circuit board.

15. An electrical connector as defined in claim 14, further including a conductive shield covering a portion of the electrically insulative body, the conductive shield including at least one grounding arm extending therefrom, the at least one grounding arm being generally parallel to a top surface of the circuit board and including a retainer for engagement with a respective retaining aperture on the circuit board.

16. An electrical connector as defined in claim 15, wherein the body includes at least one locating block, the locating block including a groove which receives the circuit board and a passageway which receives the at least one grounding arm.

17. An electrical connector as defined in claim 16, wherein the at least one locating block includes a flexible arm disposed in the groove, the flexible arm including a portion for engaging a respective retaining aperture on the circuit board.

18. A conductive shield for use in connection with an electrically insulative body of an electrical connector, the conductive shield comprising:
a conductive plate covering a portion of the electrically insulative body;
at least one grounding arm extending transversely from the conductive plate; and
a retainer provided on the at least one grounding arm for engagement with a respective retaining aperture on a circuit board, the circuit board and the grounding arm being generally parallel to each other.

19. A conductive shield as defined in claim 18, wherein the retainer is a protruded hook having a first end connected to the grounding arm and a second end suspended therefrom, and wherein the second end of the protruded hook terminates in a smoothly arched face.

20. A conductive shield as defined in claim 18, wherein the retainer is a semispherical shell which protrudes from the at least one grounding arm.
